(19) United States
(12) Patent Application Publication
(10) Pub. No.: US 2005/0189369 A1
(43) Pub. Date: Sep. 1, 2005

(54) Theft deterrent system

(76) Inventors: Kirk Vlastakis, Clemmons, NC (US); Richard Andrews, Winston Salem, NC (US); Paul Dowd, Bronxville, NY (US); Roger K. Miller, East Bend, NC (US); David Shealey, Lewisville, NC (US)

Correspondence Address: JOHN S. PRATT, ESQ;KILPATRICK STOCKTON, LLP, 1100 PEACHTREE STREET, ATLANTA, GA, 30309, US

(21) Appl. No.: 10/967,811

(22) Filed: Oct. 18, 2004

Related U.S. Application Data
(60) Provisional application No. 60/512,454, filed on Oct. 17, 2003.

(51) Int. Cl. G07F 11/00; B65H 3/44; B65G 59/00

(52) U.S. Cl. 221/123

(57) ABSTRACT

Apparatus for dispensing products is disclosed. Certain embodiments of the apparatus include a housing adapted to store a plurality of products, at least one product dispensing mechanism within the housing, at least one theft deterrent mechanism for securing products within the housing, a power source within the housing, an electric motor within the housing for activating the product dispensing mechanism, and an operable control button mounted on the exterior of the housing and electronically connected to the power source and the motor so that activation of the button operates the motor. The apparatus may include a time delay to prevent multiple dispensing within a particular time period. The apparatus may include a sound producing mechanism to alert others of the dispensing of a product.

### CROSS-REFERENCE TO RELATED APPLICATIONS

This application claims priority to U.S. patent application Ser. No. 60/512,457, filed on Oct. 17, 2003.

### BACKGROUND OF THE INVENTION

1. Field of the Invention

The invention relates generally to theft deterrent devices for dispensing products. More specifically, the invention relates to dispensing devices that incorporate theft deterrent measures, such time delays and sound.

2. General Background

Theft of small items in retail stores is an all too common problem. Items that are in high demand by thieves include over-the-counter (OTC) products such as analgesics and cough and cold medications, razor blades, camera film, batteries, videos, DVDs, smoking cessation products and infant formula. Shelf sweeping is a particular problem for small items. Shelf sweeping occurs when individuals or groups remove all the shelf stock and exit the store, similar to a “smash and grab” shoplifting technique. Shelf sweeping relies on excessive quantities of product being available on the shelf. Retailers must keep substantial inventory on shelf or incur the cost of constantly restocking.

In addition to preventing theft, retail stores may want to limit the purchase of certain items. For example, to make methamphetamine, large quantities of cold medication are needed. Pseudoephedrine, the sole active ingredient in many cold medicines and decongestants, is also a key ingredient in methamphetamine, a powerful and highly addictive stimulant.

Retailers are constantly challenged to balance the needs of legitimate consumers' access to high theft items with measures to minimize the incidence of theft. It has long been known to place items such as cigarettes, sodas and newspapers in vending machines. Such machines require complete self-service by the customer. The customer places money into the vending machine and the machine dispenses the desired item. Typical vending machines, however, do not allow for variation in product size and can only vend the particular item that they were designed for. Additionally, typical vending machines may be inconsistent with the way that people currently purchase items; many people prefer to use credit or debit cards instead of cash. Vending machines also occupy a great deal of space. Finally, typical vending machines do not employ any mechanism to prevent a purchaser from quickly dispensing all the items in the vending machine.

Because theft has become so rampant in certain product categories, such as razors and infant formula, many retail stores are taking the products off the shelves and placing them behind the counter or under lock and key. Customers must request the products in order to make a purchase. This requires additional labor costs to provide individual service to customers who would normally not require it. It also makes it difficult for customers to compare products. Furthermore, it may be impossible where the space behind the counter is limited and is needed for prescription medications. In some cases, products are simply unavailable due to high pilferage rates. Therefore, a device or dispensing apparatus that minimizes the incidence of product theft is needed.

A common problem at pharmacies and grocery stores is ensuring that consumers have access to cold medication, but at the same time deterring theft or multiple purchases for the production of drugs. A solution to the problem of sweeping is to limit the amount of cold medicine each customer is allowed to purchase. However, this requires additional labor and is not feasible where many stores now allow customers the option to check themselves out without the help of a cashier. Furthermore, this solution also keeps lawful products out of the hands of lawful consumers. Finally, legislation may be required to in order to limit such purchases. A device or dispensing apparatus that minimizes the likelihood of sweeping or unusually high numbers of multiple purchases is needed.

Such a device or dispensing apparatus should also be able to fit within common grocery, drug store or other retail environment shelves. It is also desirable that the device or dispensing apparatus effectively display the products so consumers can easily identify the products. It is also preferable that the dispensing apparatus be easy to use.

### BRIEF SUMMARY OF THE INVENTION

In certain embodiments of the invention, the apparatus for dispensing products includes a housing adapted to store a plurality of products, at least one product dispensing module, a locking mechanism for securing products within the housing, a motor within the housing for activating the product dispensing module, at least one theft deterring mechanism and an operable control button mounted on the exterior of the housing and connected to the motor so that activation of the button operates the motor, causing the at least one product to be dispensed. The product dispensing module includes a moveable surface for pushing products toward the front of the housing, a mechanism for moving at least one product from a stand-by position to a dispensing position and at least one product retaining structure for preventing access to the products prior to dispensing.

According to other embodiments, the apparatus for dispensing products includes a housing adapted to store a plurality of products, at least one product dispensing module, at least one theft deterring mechanism, a locking mechanism for securing products within the housing, a motor within the housing for activating the product dispensing mechanism and an operable control button mounted on the exterior of the housing and connected to the power source and the motor so that activation of the button operates the motor, causing at least one product to be dispensed. The product dispensing module includes a moveable surface for pushing the products toward the front of the housing, a lifting mechanism for raising at least one product to be dispensed and a gate for blocking access to the products prior to dispensing.

In still other embodiments, the apparatus for dispensing products includes a housing adapted to store a plurality of products, a plurality of product dispensing modules, at least one theft deterring mechanism comprising a sound producing mechanism for producing an audible sound when a product is dispensed, a locking mechanism for securing products within the housing, a motor within the housing for activating the product dispensing module, an operable control button mounted on the exterior of the housing and connected to the power source and the motor so that activation of the button operates the motor, and a time delay following the dispensing of at least one product. The plurality of product dispensing modules may be linked so that products are dispensed separately, with at least a five second delay between dispensing. The product dispensing modules may include a moveable wall for pushing the products toward the front of the housing, a lifting mechanism for raising at least one product to be dispensed and a gate for blocking access to the products.

### BRIEF DESCRIPTION OF THE DRAWINGS

FIG. 1 is a front perspective view of an assembled dispenser according to certain embodiments of the invention.

FIG. 2 is an exploded view of the assembled dispenser of FIG. 1.

FIG. 3 is a front perspective view of an assembled dispenser according to certain embodiments of the invention in a starting position before products, which are shown by broken lines, are dispensed.

FIG. 4 is a front perspective view of a dispensing module of a dispenser according to certain embodiments of the invention in a standby position before products are dispensed, with products and an outer housing shown by broken lines.

FIG. 5 is an enlarged fragmentary view of the components of a dispensing module of a dispenser according to certain embodiments of the invention.

FIG. 6 is a rear perspective view of a dispensing module of a dispenser according to certain embodiments of the invention in a second position as products are dispensed, with products and an outer housing shown by broken lines.

FIG. 7 is a rear perspective view of a dispensing module of a dispenser according to certain embodiments of the invention in a third position as products are dispensed, with products and an outer housing shown by broken lines.

FIG. 8 is an enlarged fragmentary view of the components of the dispensing module of FIG. 4.

FIG. 9 is a rear perspective view of a dispensing module of a dispenser according to certain embodiments of the invention in a fourth position as products are dispensed, with products and an outer housing shown by broken lines.

FIG. 10 is an enlarged fragmentary perspective view of the components of the dispensing module of FIG. 9.

FIG. 11 is a front perspective view of a dispensing module of a dispenser according to certain embodiments of the invention in a loading position before products are loaded into the dispenser, with an outer housing shown by broken lines.

FIG. 12 is a rear perspective view of the dispensing module of FIG. 11.

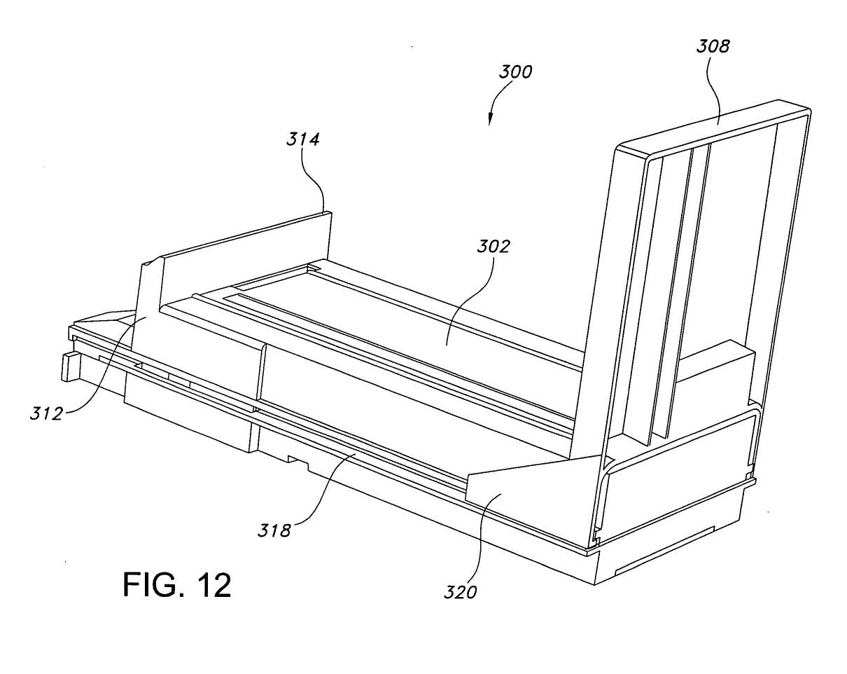

FIG. 13 is an enlarged fragmentary perspective view of the components of the dispensing module of FIG. 11.

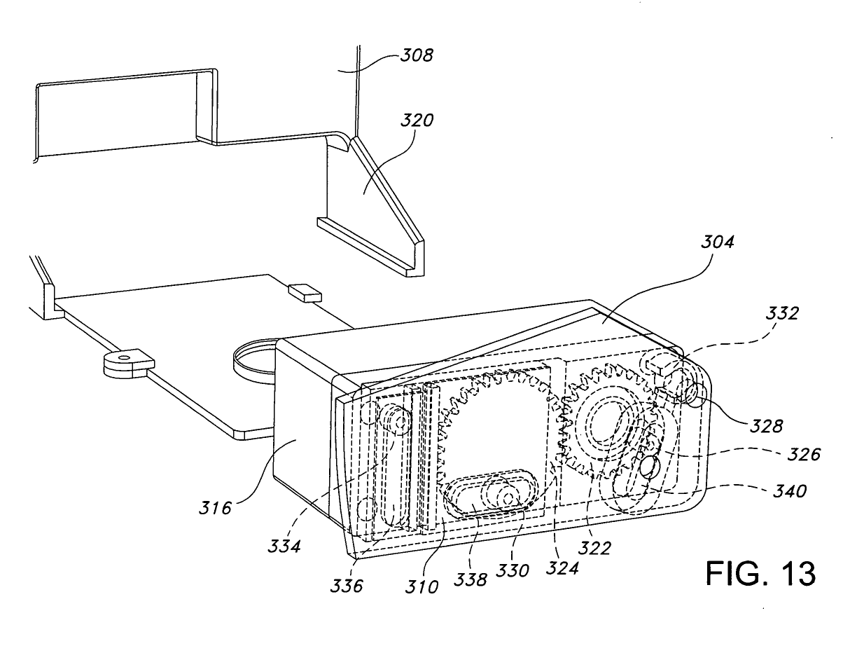

FIG. 14 is a front perspective view of a dispensing module according to alternative embodiments of the invention.

FIG. 15 is a front perspective view of a partially constructed dispensing module according to alternative embodiments of the invention.

### DETAILED DESCRIPTION

Embodiments of the invention will now be described more fully with reference to the drawings.

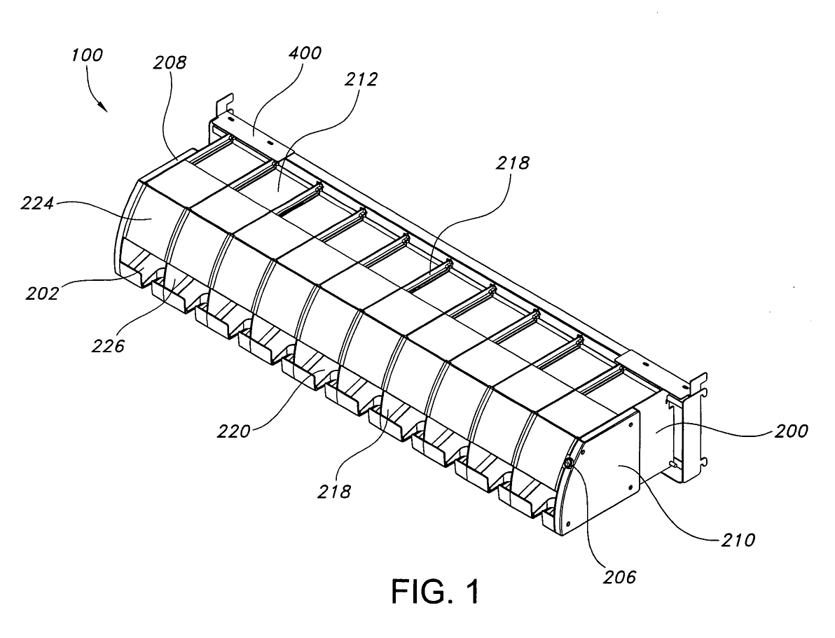

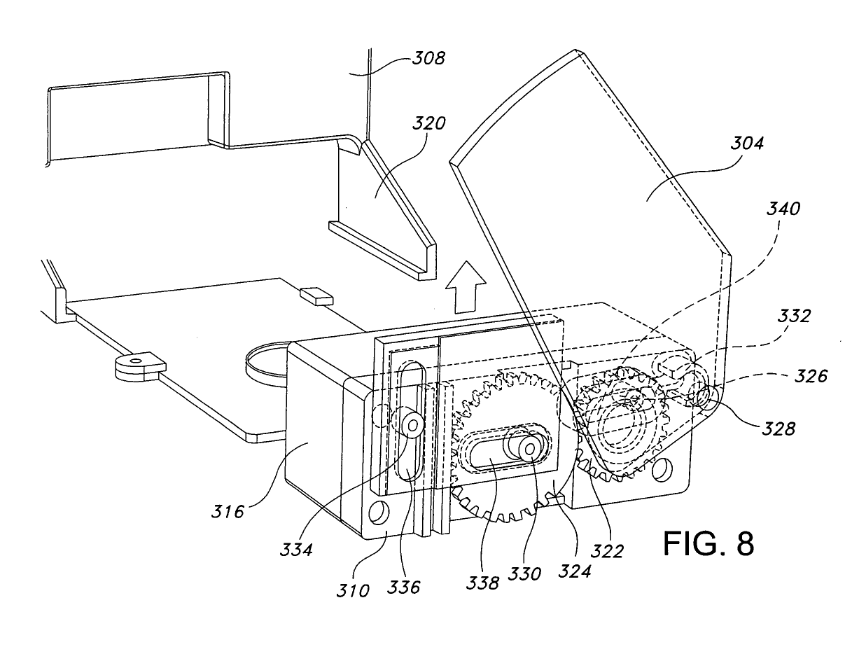

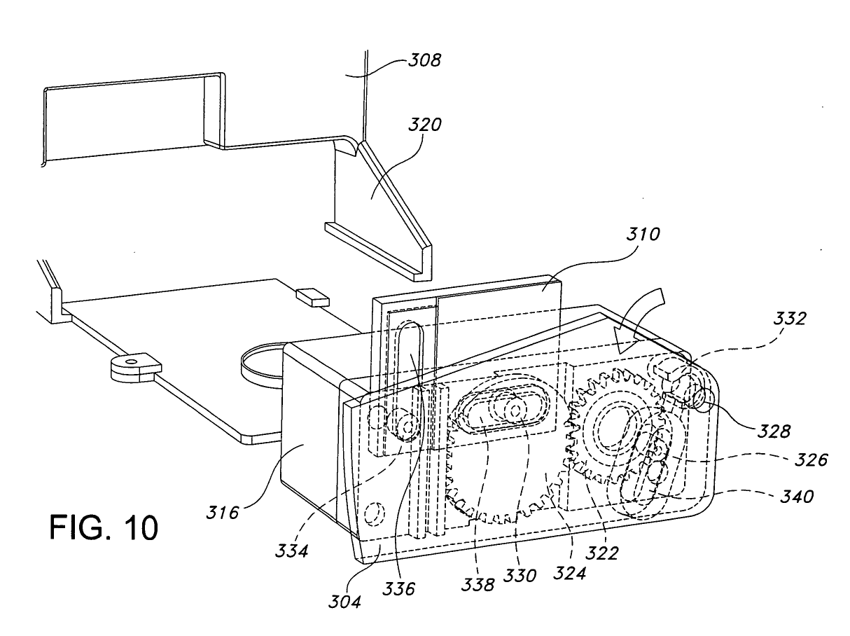

Certain embodiments of the dispenser 100 are shown in FIGS. 1-11. The dispenser 100 includes a housing or outer security cabinet 200 and a plurality of dispensing modules 300. The outer security cabinet 200 may be a single piece or may be constructed from a series of panels. Certain embodiments of the outer security cabinet 200 is shown in FIG. 1. The outer housing 200 consists of a series of panels joined together. The outer housing 200 may have an overall rectangular configuration with side panels 208, 210, and top and bottom panels 212, 214 defining an inner compartment 220. The outer housing 200 may, but does not have to, include a rear panel (not shown) to further define inner compartment 220. However, in some embodiments, access to the rear of the outer housing 200 is restricted by the securing the dispenser 100 to a shelf. Partition walls 218 may be used to divide the inner compartment 220 into separate receptacles 222 for product dispensing modules 300, described further below.

In some embodiments, the outer security cabinet 200 includes a bottom panel 214 and a top panel 212. The top panel 212 may include integrated side panels or side panels 208, 210 may be separately provided. Similarly, the top panel 212 or bottom panel 214 may have an integrated rear panel or a rear panel 216 may be separately provided.

To prevent thieves from simply removing products 102 from the product dispensing module 300, the outer housing 200 may include a front panel 224. Preferably, the front panel 224 is clear, so that the products 102 can be viewed easily by purchasers. According to certain embodiments, the window is preferably constructed of a clear plastic or other material to allow viewing of the product and to take advantage of its lightweight, yet shatterproof properties. Preferably, the window is made of polycarbonate.

In some embodiments, the front panel 224 covers substantially the entire front of the outer housing 200, with an opening big enough for only a product to fall through. If the front panel 224 covers substantially the entire front of outer housing 200, it may be removable or moveable to allow restocking of the dispenser 100. In other embodiments, the front panel 224 only partially covers the front of the outer housing 200. In these embodiments, the front panel 224 does not need to be moved or removed for restocking.

In certain embodiments, the front panel 224 is reinforced by a metal bar to prevent would-be thieves from simply breaking the front panel 224.

The top panel 212 may also be clear to allow retailers to easily determine when the dispenser needs to be restocked with goods.

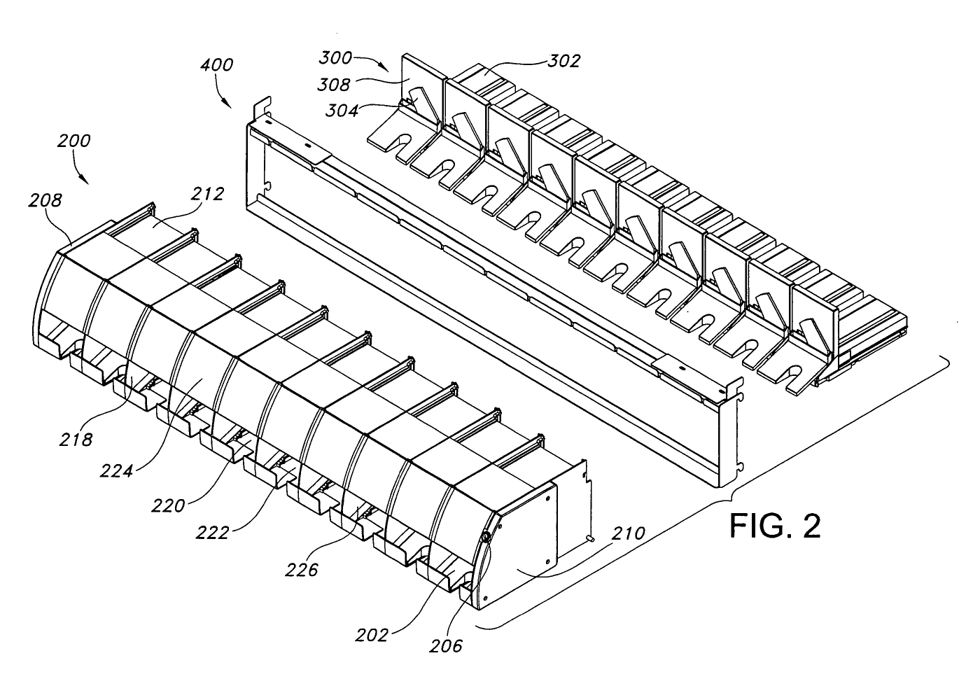

Within the outer security cabinet 200 is at least one dispensing module 300, as shown in FIG. 2. The dispensing module 300 includes a product tray 302 on which products 102 are placed. The product tray 302 may include a compartment 316 to house electro-mechanical elements, including circuit boards, motors, springs, batteries, clickers, speakers or any other electro-mechanical elements necessary for the dispenser 100. The product tray 302 may also elevate the products 102 so that they may be more easily viewed by consumers.

The products 102 are held in place and pushed forward by a product feed panel 308. In some embodiments, the product feed panel 308 may include arms 320 attaching it to the product tray 302. The arms 320 fit into product feed panel tracks 318 on each side of the product feed tray 302. The tray 302 is pulled forward by a constant force spring (not shown). In other embodiments, the product feed panel 308 does not include arms 320, but includes a projection that fits in a groove or slot on the upper surface of the product tray 302. In these embodiments, the product feed panel 308 may still be pulled forward by a coil spring. This keeps the next product 102 to be dispensed up front and against product blocker gate 304, described further below.

In some embodiments of the invention, the dispensing module 300 also includes a product blocker gate 304 to retain products within the dispensing module 300. The product blocker gate 304, in conjunction with a stop wall 312 and clearance lip 314, prevents the products 102 from moving forward and into the product pick-up area 202 prior to dispensing. In certain embodiments, the product blocker gate 304 is constructed of a clear plastic material to allow easy viewing of the products 102.

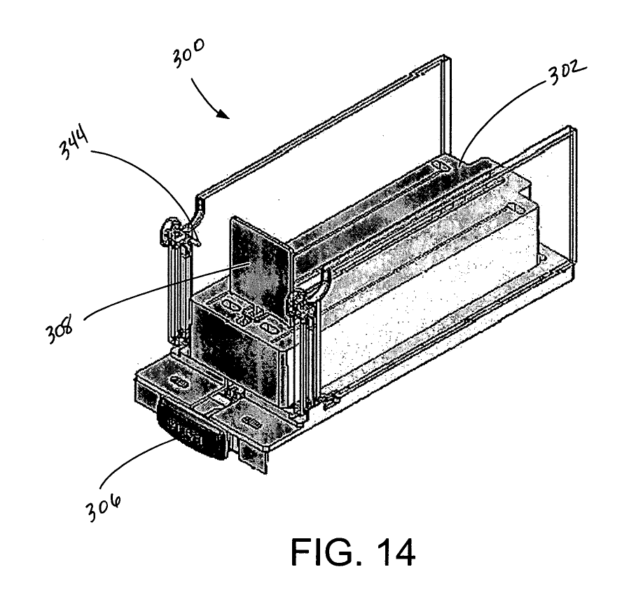

In certain embodiments, the theft deterrent mechanism includes the use of two gates 344 to retain products within the dispensing module 300 (shown in FIG. 14). The gates 344 are generally in the closed position and may be opened by activating a spring (not shown). The mechanism is controlled by a circuit board. When a consumer presses the dispensing button 306, an electric motor cycles, opening the gates 344. Opening the gates 344 allows a product 102 to be removed. Once the product 102 has been removed, the spring snaps back to its original position and pushes gates 344 closed. To deter theft, the dispenser 100 includes a time delay, also controlled by the circuit board, between the pressing of the dispensing button 306 and the opening of the gates 344. This prevents thieves from “sweeping” or rapidly dispensing multiple products from the dispenser 100. Also included is a lock (not shown) which rotates into place when the gates 344 close. The lock prevents the gates 344 from being opened manually.

In certain embodiments, the dispensing module 300 may include a product lifter 310 to dispense products 102. The product lifter 310 raises the product 102 to be dispensed above the stop wall 312 and clearance lip 314, so that the product 102 can fall into the product pick-up area 202 by gravity.

In other embodiments of the invention, the dispenser 100 includes a product dispensing ram (not shown) to dispense products 102. The ram may be positioned slightly above or slight below the forward-most product 102 in the dispensing module 300 and is connected to a spring-loaded button 306. Depression of the button 306 causes the ram to force a single product 102 upwardly or downwardly, depending on the location of the ram. It will be understood that the location of the ram will also dictate where an opening will be located for dispensing the product. For example, if the ram is positioned slight above the forward-most product 102 in the row, the opening will be below the product 102 and depressing the button 306 will cause the ram to force a single product 102 downwardly.

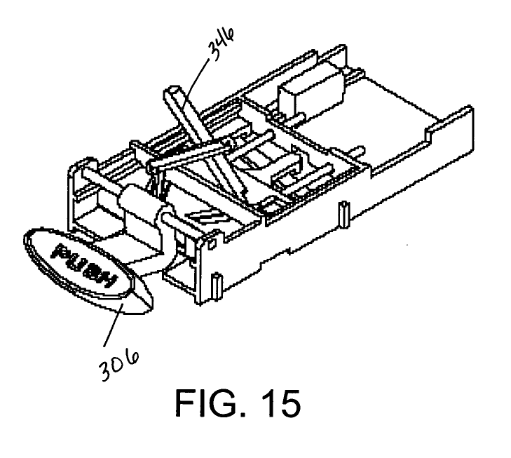

Certain embodiments of the invention include a scissor-like lifter 346, as shown in FIG. 15. As described above, a spring-loaded product feed panel 308 pushes the product 102 towards the front of the dispensing module 300 each time a product 102 is removed from the dispenser 100. The product 102 is dispensed using scissor-like lifter arms that push the product 102 up and out of dispenser 100.

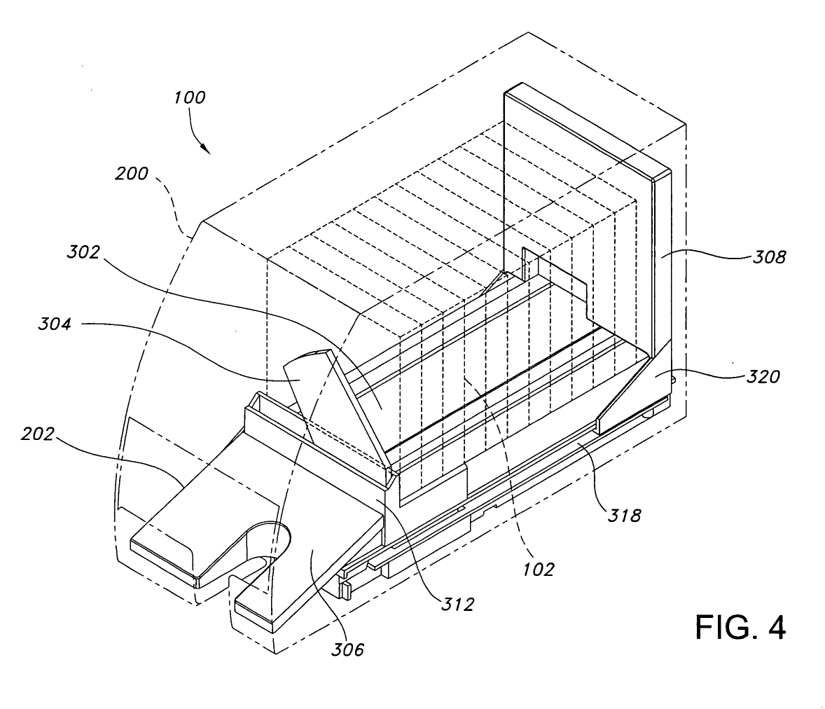

Each dispensing module 300 is capable of dispensing a plurality of products 102, as shown in FIGS. 4, 7 and 11.

As shown in FIG. 4, when loaded with products 102, the dispensing module 300 maintains a standby position until a user activates the dispensing mechanism. Depending on the number of products 102 in the dispenser and the size of those products 102, the product feed panel 308 is pushed back a distance on the product tray 302. The product blocker gate 304 may be in a raised position, and preferably, is in its uppermost position.

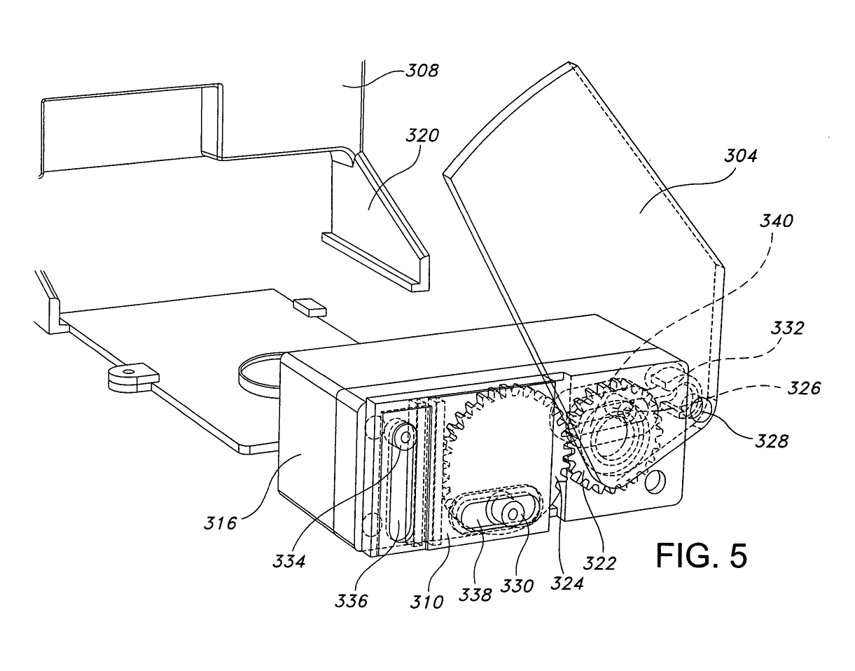

FIG. 5 details the mechanism of the dispensing module 300 in the standby position. As shown in FIG. 5, when the dispensing module 300 is in the standby position, the product lifter 310 is recessed into the product tray 302 so that the product 102 to be dispensed is not elevated off the product tray 302. Because the dispensing module 300 is enclosed on the top and sides by the outer security cabinet 200, the raised product blocker gate 304 and recessed product lifter 310 prevent users from accessing the products without activating the dispenser 100.

According to certain embodiments, the dispenser 100 is electromechanical. Depending on the needs of the retailer, the dispenser may operate on DC power or by batteries. Each dispensing module 300 includes compartment 316. Compartment 316 includes a power source (not shown). One example of a convenient power source is a battery, however, other power sources, such as a cord connected to an electrical outlet may be used. The compartment 316 includes a circuit board (not shown) which is connected to a product dispensing button 306. The product dispensing button may be located on the outer housing 200 and extend through a hole in the front wall of the housing 200 and the module 300 or it may be located in an accessible area on the module 300. An electric motor is mounted in compartment and is connected to the circuit board by wires. The battery contacts are in electrical contact with the spring contacts and the circuit board is in electrical contact with the motor.

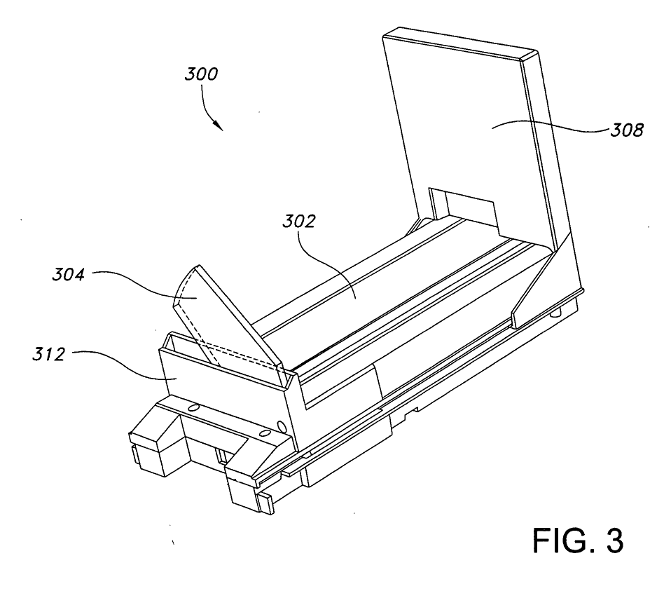

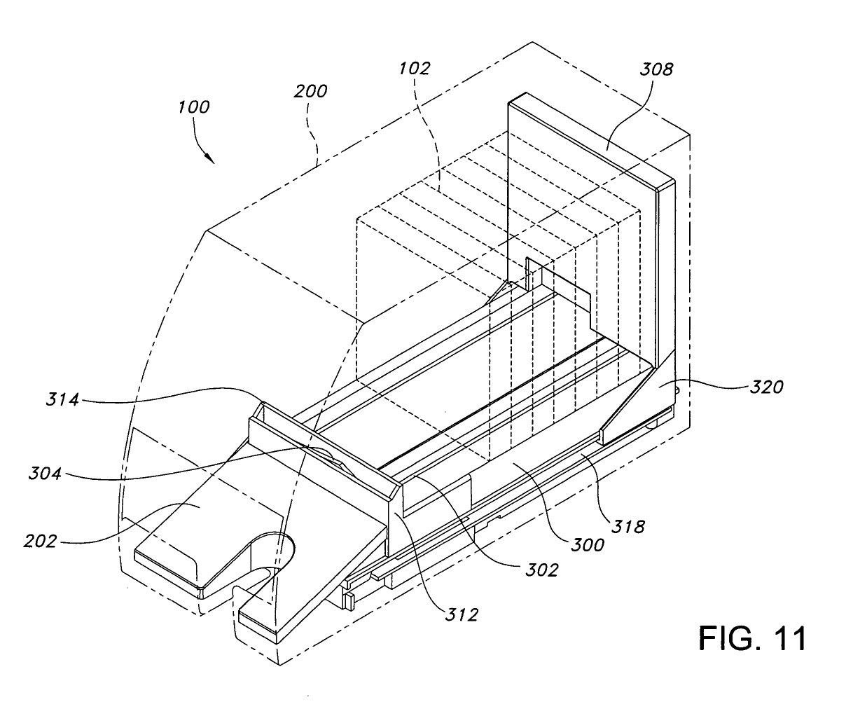

A user presses the button 306 to begin the dispensing cycle. When the button 306 is pressed, an electric motor rotates gear 322. As gear 322 rotates, sliding arm 326 moves downwardly. Because sliding arm 326 is positioned in sliding socket 340, rotation of gear 322 and movement of sliding arm 326 causes product blocker gate 304 to move downwardly. Product blocker gate 304 thus moves from the standby position shown in FIG. 3, to the dispensing position shown in FIG. 11 and back to the standby position of FIG. 3.

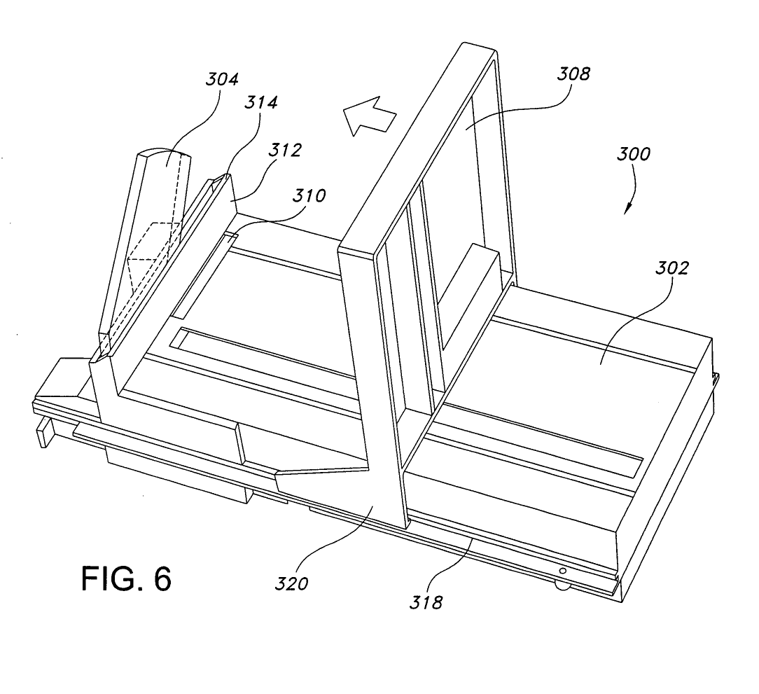

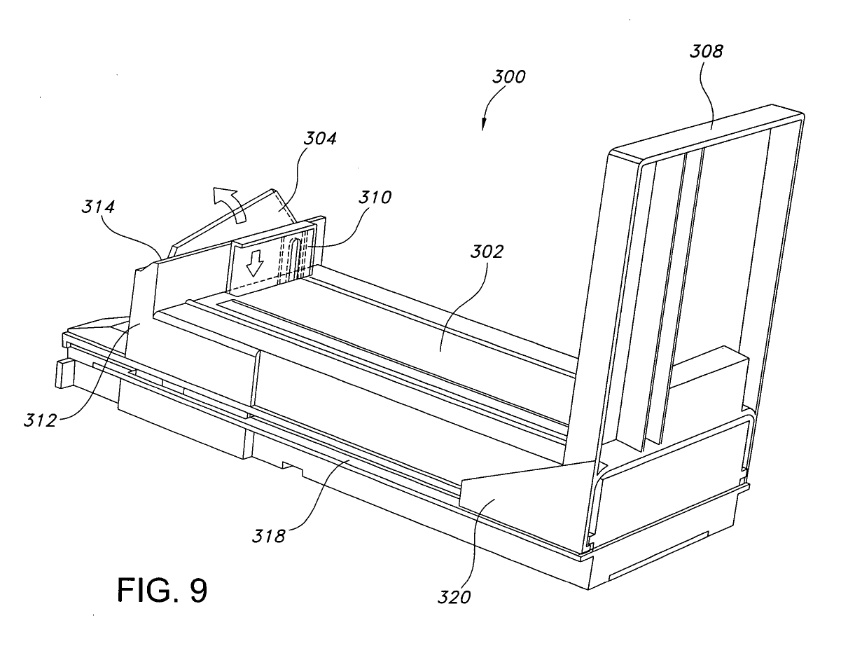

As gear 322 rotates, the teeth of gear 322 engage the teeth of gear 324. This causes gear 324 to rotate. As gear 324 rotates, sliding arm 330 moves upwardly. Sliding arm 330 is positioned in a horizontal sliding slot 338 on product lifter 310. When gear 324 has rotated far enough that sliding arm 330 engages an end of horizontal sliding slot 338, product lifter 310 moves upwardly. Sliding arm 334 is position in a vertical sliding slot 336 on product lifter 310. As product lifter 310 moves upwardly, sliding arm 334 guides product lifter 310 and helps maintain its orientation. Product lifter 310 thus moves from the standby position shown in FIG. 6, to the dispensing position shown in FIG. 9 and back to the standby position of FIG. 6.

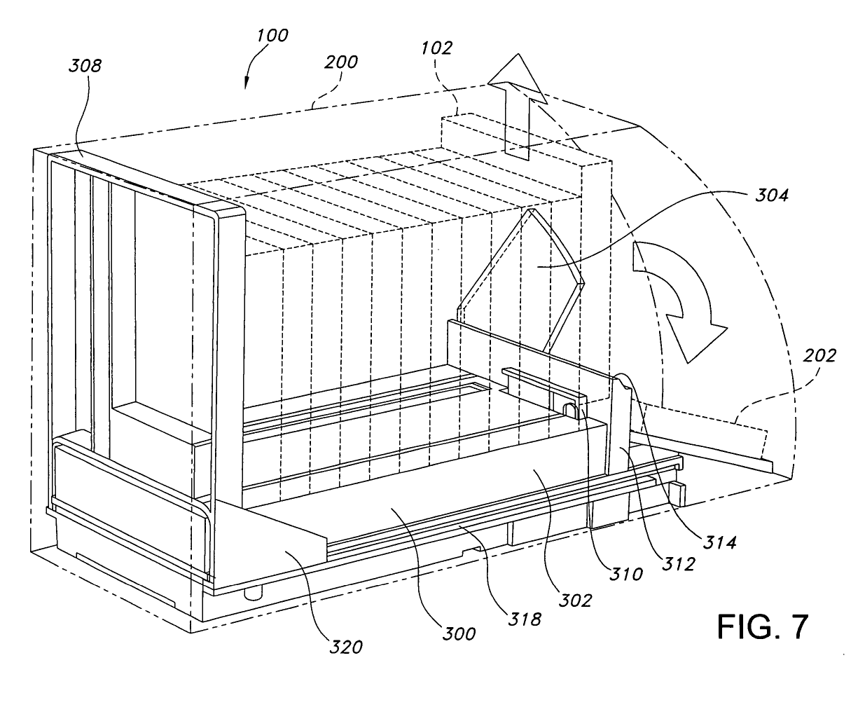

The product feed panel 308 applies constant pressure on the products 102, which are pushed forward toward the product blocker gate 304 and the stop wall 312. When the product dispensing button 204 is depressed, the product blocker gate 304 moves downwardly, as shown in FIG. 7. Correspondingly, the product lifter 310 moves upwardly and raises the product 102 to be dispensed. The product lifter 310 raises the product 102 past the stop wall 312. When the product blocker gate 304 is completely lowered, the product 102 moves beyond the clearance lip 314 due to pressure from the product feed panel 308 and falls into the product pick up area 202.

When the product 102 is released into the product pick-up area 202, the product blocker gate 304 raises back to its fully upright position to prevent the next product 102 from being removed. The motor preferably cycles once more as another product 102 moves forward. The next product 102 will not be dispensed until the motor has completed the cycle.

To further deter theft, the dispenser 100 may include a sound to alert store employees that a product is being dispensed. The dispenser 100 preferably includes means for producing a clearly audible sound. For example, the dispenser may include a clicker for providing an audible clicking sound. The clicker may be incorporated into a spring so that the sound is heard when the spring is recoiled after engaging the product dispensing button 306. In other embodiments, the dispenser 100 can include an audible beeping sound. For example, engaging the button 306 may activate the circuit board, which in addition to activating the motor, can activate an electronically produced beeping sound. The device may also deliver an audible message, such as a sound, when a product is dispensed. The audible sound alerts persons in the vicinity that a product is in the position to be removed. This may attract the attention of a store clerk or others and deter thieves.

To dispense the next product 102, the product dispensing button 306 must be activated again. As with the first product 102, the dispenser 100 beeps for 5-20 seconds while dispensing the next product 102. The next product 102 is not dispensed until the motor has completed its cycle and thus, there is a time delay between the dispensing of products 102. Because the dispenser 100 is secured with a lock assembly 206, consumers must carry out the above described steps in order to dispense the product 102.

In other embodiments, the time-delay may be effected by a delayed release of the button 306. Thus, a period of time passes before the button 306 returns to its original position and a second product 100 can be dispensed. This prevents the dispensing of multiple products 102 at once and makes theft of the product difficult.

In other embodiments, the time-delay may be effected by a delayed release of the button. Thus, a period of time passes before the button returns to its original position and a second product can be dispensed. This prevents the dispensing of multiple products at once and makes theft of the product difficult.

It will also be understood that the dispensing modules 300 may be separately engaged by pressing the product dispensing button 306 or may be linked electronically. The advantage of linking the dispensing modules 300 is that a time delay between dispensing modules 300 may be effected so that when the product dispensing button 306 on a first module 300 has been engaged to dispense a product, a period of time must pass before a second separate module will dispense a product 204. This further minimizes the likelihood of theft or multiple purchases.

The dispenser 100 may be of any dimensions so that it will fit on a store shelf. Similarly, the dispensing modules 300 may be of any size and dimensions to fit the products 102 desired to be dispensed. The dispensing module 300 does not include side walls or a top wall and thus, different sized products can be accommodated by the same dispensing module 300. The number of dispensing modules 300 that will fit within the dispenser 100 will depend on the size of the dispenser 100 and the size of the product 102 to be dispensed. Furthermore, the number of products 102 that may be dispensed by the dispenser 100 will vary based on the size of the dispenser.

The dispenser 100 may be placed on a retail counter or may be conveniently attached to shelves, shelf standards or free-standing merchandizing displays in a retail store. In some embodiments, the dispenser 100 may be secured to the shelves or shelf standards in a store with a bracket 400, shown in FIGS. 1 and 2. The dispenser may be secured to horizontal shelves or the shelves may be slanted downwardly to better display the products 102 within the dispenser 100. According to certain embodiments, the dispenser 100 is secured to the shelves by attaching the outer security cabinet 200 to the shelves.

The dispenser 100 also includes controlled access for restocking. For example, the dispenser may include a locking mechanism to prevent consumers from simply pushing down the product blocker gate 304 and obtaining access to the products 102 without encountering the theft deterrent mechanisms, such as the time delay and the sound. The locking mechanism may be a keyed lock 206 on the outer housing 200. The lock 206 may be connected to the operation of the product blocker gate 304 and the lifter 310. For example, when a key is inserted into the lock 206 and the lock 206 is placed in a vertical position, the dispenser 100 may be in a “dispensing” mode, ready to dispense products 102. When the key is inserted into the lock 206 and turned to approximately 900 from the vertical position, the dispenser 100 may be in an “off” mode. This feature is particularly useful when a store is closed (to prevent employee theft) or during high theft hours. The key may be removed from the lock 206 when it is in either of these positions so that the dispenser 100 can remain in the dispensing or off mode for an extended period of time.

The locking mechanism may also control access for restocking the dispenser 100. For example, the key may be inserted into the lock 206 and turned to approximately 135° from the vertical position. When the key is in this position and the product dispensing button 306 is depressed, the product blocker gate 304 is lowered allowing access to the product tray 302. In this position, the key cannot be removed. Thus, it is virtually impossible for the dispenser 100 to be left in a position in which the theft deterrent mechanisms can be bypassed. To raise the product blocker gate 304 again, the key is turned back to 90° or vertical, so that the dispenser is in either the “off” or “dispensing” mode.

The foregoing description is provided for describing various embodiments and structures relating to the invention. Various modifications, additions and deletions may be made to these embodiments and/or structures without departing from the scope and spirit of the invention.

1. Apparatus for dispensing products comprising:
(a) a housing adapted to store a plurality of products;
(b) at least one product dispensing module within the housing comprising:
a moveable surface for pushing products toward the front of the housing;
a mechanism for moving at least one product from a stand-by position to a dispensing position; and
at least one product retaining structure for preventing access to the products prior to dispensing;
(c) a locking mechanism for securing products within the housing;
(d) a motor within the housing for activating the product dispensing module;
(e) at least one theft deterring mechanism; and
(f) an operable control button mounted on the exterior of the housing and connected to the motor so that activation of the button operates the motor, causing at least one product to be dispensed.

2. The apparatus of claim 1, wherein the mechanism for moving at least one product from a stand-by position to a dispensing position is a lifting mechanism.

3. The apparatus of claim 2, wherein the lifting mechanism is a block that is raised and lowered by gears.

4. The apparatus of claim 2, wherein the lifting mechanism is a pair of scissor-like arms.

5. The apparatus of claim 1, wherein the mechanism for moving at least one product from a stand-by position to a dispensing position is ram for pushing at least one product downwardly.

6. The apparatus of claim 1, wherein the product retaining structure is a gate that is raised and lowered by gears.

7. The apparatus of claim 1, wherein the product retaining structure a pair of spring-loaded gates.

8. The apparatus of claim 1, wherein the theft deterring mechanism comprises a time delay of at least five seconds between the dispensing of products.

9. The apparatus of claim 1, wherein the theft deterring mechanism comprises a sound producing mechanism for producing an audible sound when a product is dispensed.

10. The apparatus of claim 9, wherein the sound producing mechanism is an electronically activated beeping sound.

11. The apparatus of claim 9, wherein the sound producing mechanism is a mechanically produced clicking sound.

12. The apparatus of claim 1, further comprising a plurality of product dispensing modules within the housing.

13. The apparatus of claim 12, wherein the plurality of product dispensing mechanisms are linked so that only one product may be dispensed from the apparatus at a time.

14. The apparatus of claim 13, wherein a time delay of at least five seconds is activated following the dispensing of a product from any one of the plurality of product dispensing mechanisms.

15. The apparatus of claim 1, further comprising means for attaching the apparatus to a shelf.

16. Apparatus for dispensing products comprising:
(a) a housing adapted to store a plurality of products;
(b) at least one product dispensing module comprising:
a moveable surface for pushing the products toward the front of the housing;
a lifting mechanism for raising at least one product to be dispensed; and
a gate for blocking access to the products prior to dispensing;
(c) at least one theft deterring mechanism;
(d) a locking mechanism for securing products within the housing;
(e) a motor within the housing for activating the product dispensing mechanism; and
(f) an operable control button mounted on the exterior of the housing and connected to the power source and the motor so that activation of the button operates the motor, causing at least one product to be dispensed.

17. The apparatus of claim 16, further comprising a time delay of at least five seconds between the dispensing of products.

18. The apparatus of claim 16, further comprising a plurality of product dispensing modules within the housing.

19. The apparatus of claim 16, wherein the theft deterring mechanism comprises a sound producing mechanism for producing an audible sound when a product is dispensed.

20. The apparatus of claim 19, wherein the audible sound is an electronically activated beeping sound.

21. The apparatus of claim 18, wherein the plurality of product dispensing modules are linked so that products are dispensed separately, with at least a five second delay between dispensing.

22. The apparatus of claim 21, wherein a time delay is activated following the dispensing of a product from any one of the plurality of product dispensing modules.

23. The apparatus of claim 16, further comprising means for attaching the apparatus to a shelf.

24. Apparatus for dispensing products comprising:
(a) a housing adapted to store a plurality of products;
(b) a plurality of product dispensing modules comprising:
a moveable wall for pushing the products toward the front of the housing;
a lifting mechanism for raising at least one product to be dispensed; and
a gate for blocking access to the products;
(c) at least one theft deterring mechanism comprising a sound producing mechanism for producing an audible sound when a product is dispensed;
(d) a locking mechanism for securing products within the housing;
(e) a motor within the housing for activating the product dispensing module;
(f) an operable control button mounted on the exterior of the housing and connected to the power source and the motor so that activation of the button operates the motor; and
(g) a time delay following the dispensing of at least one product;
wherein the plurality of product dispensing modules are linked so that products are dispensed separately, with at least a five second delay between dispensing.
